(19) United States
(12) Patent Application Publication
(10) Pub. No.: US 2025/0051631 A1
(43) Pub. Date: Feb. 13, 2025

(54) COMPOSITIONS AND METHODS FOR DISSOLVING DEPOSITS AND INHIBITING CORROSION

(71) Applicant: ECOLAB USA Inc., St. Paul, MN (US)

(72) Inventors: Ashish DHAWAN, Aurora, IL (US); Carter Martin SILVERNAIL, Lakeville, MN (US); Emily Rebecca WOOD, Naperville, IL (US); Jonathan Todorova MASERE, Richmond, TX (US)

(73) Assignee: ECOLAB USA Inc., St. Paul, MN (US)

(21) Appl. No.: 18/796,635

(22) Filed: Aug. 7, 2024

Related U.S. Application Data
(60) Provisional application No. 63/518,507, filed on Aug. 9, 2023.

(51) Int. Cl. C09K 8/532; C09K 8/54

(52) U.S. Cl. CPC C09K 8/532; C09K 8/54; C09K 2208/32

(57) ABSTRACT

The present disclosure provides methods and compositions for dissolving deposits and inhibiting corrosion of metallic surfaces in aqueous systems. A method may include adding a composition to the aqueous medium. The composition may include a polycarboxylate polymer and a nitrogen-containing compound. The composition may optionally include a solvent and/or an additive. The compositions and methods may be used for inhibiting corrosion of metallic surfaces and dissolving typical insoluble inorganic salts encountered in the oil and gas, recovery, water, and processing industries.

### TECHNICAL FIELD

The present disclosure provides compositions and methods for inhibiting corrosion and removing oilfield deposits, such as hydrocarbon and/or iron sulfide-based deposits, from equipment.

### BACKGROUND

As oilfields age, the amount of oil produced decreases and the amount of water produced with the oil increases. The water is usually disposed of or injected back into the formation to maintain reservoir pressure. The separation process is efficient, but not perfect, and a small fraction of oil and other debris can be present after the fluids pass through the separation equipment. That residual fraction of oil in water carryover can cause significant problems as the field ages.

Fields can produce as much as 1,000,000 barrels of water each day. The residual oil and other particles, such as paraffin, asphaltenes, iron sulfide and biomass can build up in the separation equipment and pipelines. If left untreated, this form of deposition can plug lines, which can lead to loss of revenue and/or equipment failure. Due to lines which cannot be mechanically cleaned, a chemical solution is needed that can be injected into the system to maintain control of the deposition in the lines.

In addition to plugging lines, deposits comprising iron sulfide may collect on internal surfaces. Such unwanted deposits may be complex mixtures of inorganic compounds, such as sand and iron sulfide, and organic compounds, such as asphaltenes and crude petroleum. The deposits are sticky and difficult to clean. Currently available cleaners for removing deposits from equipment used in oil and gas applications aid in the removal of the organic deposition but are less effective against the inorganic deposition, especially iron sulfide. Conventional cleaners may disperse iron sulfide, but are relatively ineffective in inhibiting or dissolving iron sulfide, providing only limited cleaning ability. Conventional cleaners may also be acidic and therefore incompatible with the metallurgy of the systems they are designed to treat.

Furthermore, the metallurgy of the systems is prone to corrosion if not properly treated.

### BRIEF SUMMARY

In certain aspects, the present disclosure provides a method of dissolving a deposit and inhibiting corrosion of a metallic surface, the method comprising adding a composition to an aqueous medium, the aqueous medium comprising the deposit and the metallic surface. The composition comprises a polycarboxylate polymer and a nitrogen-containing compound, the nitrogen-containing compound comprising an amine, an imine, or a combination thereof. The method also comprises dissolving at least a portion of the deposit and inhibiting corrosion of the metallic surface, wherein the composition is added to the aqueous medium at a concentration of at least about 0.005 wt. %.

In some embodiments, the amine is a tertiary amine or a quaternary amine.

In some embodiments, the nitrogen-containing compound is a cyclic compound. In certain embodiments, the nitrogen-containing compound is an imidazoline compound, a quaternary ammonium compound, a quaternary iminium compound, a zwitterionic betaine compound, an amidoamine compound, a pyridinium compound, or any combination thereof. In some embodiments, the nitrogen-containing compound is:
(A) an imidazoline of Formula (I):

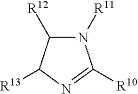

wherein R¹⁰ is a C₁-C₂₀ alkyl group or a C₁-C₂₀ alkoxyalkyl group; R¹² and R¹³ are independently selected from hydrogen or a C₁-C₆ alkyl group; and R¹¹ is hydrogen, a C₁-C₆ alkyl group, a C₁-C₆ hydroxyalkyl group, an aminoalkyl group, an aminoaryl group, an aminoarylalkyl group, an aminoalkylaryl group, or a C₁-C₆ arylalkyl group;
(B) an imidazolinium salt of Formula (II):

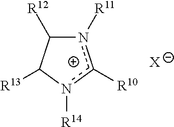

wherein R¹⁰ is a C₁-C₂₀ alkyl group or a C₁-C₂₀ alkoxyalkyl group; R¹² and R¹³ are independently selected from hydrogen or a C₁-C₆ alkyl group; R¹¹ and R¹⁴ are independently selected from hydrogen, a C₁-C₆ alkyl group, a C₁-C₆ hydroxyalkyl group, or a C₁-C₆ arylalkyl group; and
X⁻ is a halide, a carbonate, a sulfonate, a phosphate, or an anion of an organic carboxylic acid;
(C) a bis-quaternized imidazoline compound of Formula (III):

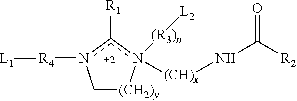

wherein R₁, R₂, R₃ and R₄, are each independently selected from a C₁-C₃₀ alkyl group, a C₁-C₃₀ alkenyl group, a C₁-C₃₀ cycloalkyl group, or a C₁-C₃₀ cycloalkenyl group; optionally wherein R₁, R₂, R₃ and/or R₄, is partially or fully oxygenized, sulfurized, and/or phosphorylized;
L₁ and L₂ are each independently selected from absent, H, —COOH, —SO₃H, —PO₃H₂, —COOR₅, —CONH₂, —CONHR₅, or —CON(R₅)₂;
R₅ is selected from a C₁-C₁₀ alkyl group, a C₄-C₁₀ aryl group, a C₅-C₁₀ alkylaryl group, a C₅-C₁₀ alkylheteroaryl group, a C₃-C₁₀ cycloalkyl group, or a C₄-C₁₀ heteroaryl group;
n is 0 or 1, and when n is 0, L₂ is absent or H;
x is from 1 to about 10; and
y is from 1 to about 5; or
(D) any combination thereof.

In some embodiments, the amine is a tertiary amine or a quaternar In some embodiments, the nitrogen-containing compound is the imidazoline of Formula (I) or the imidazolinium salt of Formula (II), R¹⁰ is an alkyl mixture of tall oil fatty acid (TOFA), R¹¹ is benzyl, R¹² and R¹³ are each hydrogen, R¹⁴ is hydroxyethyl, and X⁻ is chloride.

In some embodiments, the nitrogen-containing compound is the bis-quaternized imidazoline compound of Formula (III), R¹ and R² are derived from a mixture of tall oil fatty acids and comprise a mixture of C₁₇H₃₃ and C₁₇H₃₁, x is 2, y is 1, R³ and R⁴ are —C₂H₂—, and L₁ and L₂ are —CO₂H, —SO₃H, or —PO₃H₂.

In certain embodiments, the nitrogen-containing compound is the bis-quaternized imidazoline compound of Formula (III), R¹ and R² are independently a C₁₆-C₁₈ alkyl group; R⁴ is —C₂H₂—; x is 2; y is 1; n is 0; L₁ is —COOH, —SO₃H, or —PO₃H₂ and L₂ is absent or H.

In some embodiments, the nitrogen-containing compound is the quaternary ammonium compound and the bis-quaternized imidazoline compound of Formula (III).

In some embodiments, the nitrogen-containing compound is a quaternary ammonium compound of Formula (IV):

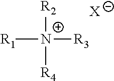

wherein R₁, R₂, and R₅ are independently selected from a C₁ to C₂₀ alkyl group, R₄ is methyl or benzyl, and X⁻ is a halide or methosulfate.

In certain embodiments, the nitrogen-containing compound comprises a pyridinium compound of Formula (V):

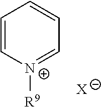

wherein R⁹ is a C₁ to C₁₈ alkyl group, a C₄ to C₁₈ aryl group, or a C₅ to C₂₀ arylalkyl group; and X⁻ is a halide.

In some embodiments, the composition further comprises an organic acid, a solvent, a diol, or a combination thereof. In some embodiments, the organic acid is acetic acid, lactic acid, formic acid, malic acid, oxalic acid, tartaric acid, uric acid, or a combination thereof.

In certain embodiments, the solvent is methanol, ethanol, trifluoroethanol, propanol, isopropanol, hexafluoroisopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, glycerin, or any combination thereof.

In some embodiments, the diol is propylene glycol, methylene glycol, ethylene glycol, 1,2-propylene glycol, 1,3-propylene glycol, diethyleneglycol, and any combination thereof.

In some embodiments, the organic acid is malic acid, the solvent is methanol, and the diol is propylene glycol.

In certain embodiments, the composition comprises from about 1 wt. % to about 50 wt. % of the polycarboxylate polymer.

In some embodiments, the polycarboxylate polymer is an acrylic acid homopolymer, an acrylic acid copolymer, a maleic acid homopolymer, or a maleic acid copolymer. In some embodiments, the polycarboxylate polymer comprises acrylic acid and maleic acid.

In certain embodiments, the composition comprises from about 10 wt. % to about 70 wt. % of the polycarboxylate polymer and from about 10 wt. % to about 70 wt. % of the nitrogen-containing compound.

In some embodiments, the aqueous medium comprises a chloride-containing salt.

In some embodiments, the chloride-containing salt is sodium chloride, calcium chloride, magnesium chloride, potassium chloride, or a combination thereof.

In certain embodiments, the aqueous medium comprises sodium bicarbonate, sodium bromide, or a combination thereof. In some embodiments, the aqueous medium comprises water, a gas, a liquid hydrocarbon, or any combination thereof.

In some embodiments, a surface in contact with the aqueous medium comprises the deposit, optionally wherein the metallic surface comprises the deposit.

In certain embodiments, the deposit comprises a member selected from the group consisting of iron sulfide, a paraffin, a hydrocarbon, an asphaltene, a biomass, and any combination thereof. In some embodiments, the deposit comprises iron sulfide and the method further comprises increasing a soluble iron percentage in the aqueous medium. In some embodiments, the soluble iron percentage increases by about 5% to about 100%.

In certain embodiments, the composition consists of or consists essentially of the polycarboxylate polymer and the nitrogen-containing compound.

In some embodiments, the composition consists of or consists essentially of the polycarboxylate polymer, the nitrogen-containing compound, and optionally the organic acid, the solvent, the diol, or any combination thereof.

The present disclosure also provides compositions. In some embodiments, a composition comprises a polycarboxylate polymer and a nitrogen-containing compound, the nitrogen-containing compound comprising an amine, an imine, or a combination thereof.

In some embodiments, the composition consists of or consists essentially of the polycarboxylate polymer and the nitrogen-containing compound. In certain embodiments, the composition consists of or consists essentially of the polycarboxylate polymer, the nitrogen-containing compound, and optionally the organic acid, the solvent, the diol, or any combination thereof.

In some embodiments, the polycarboxylate polymer is at least partially neutralized.

In some embodiments, the polycarboxylate polymer is phosphonate terminated.

In certain embodiments, the composition further comprises an additive selected from the group consisting of an asphaltene inhibitor, a solvent, a paraffin inhibitor, a scale inhibitor, an emulsifier, a water clarifier, a dispersant, an emulsion breaker, a hydrogen sulfide scavenger, a gas hydrate inhibitor, a biocide, a pH modifier, an antifoam, a surfactant, a chelating agent, a hydroxycarboxylic acid, a sugar acid, and any combination thereof.

In some embodiments, the composition consists of or consists essentially of the polycarboxylate polymer, the nitrogen-containing compound, and the additive.

In some embodiments, the composition consists of or consists essentially of the polycarboxylate polymer, the nitrogen-containing compound, and a solvent.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1 shows the results of an iron sulfide dissolution test conducted in DI water, and

FIG. 2 shows the results of an iron sulfide dissolution test conducted in 3% KCl brine.

### DETAILED DESCRIPTION

Unless otherwise defined, all technical and scientific terms used herein have the same meaning as commonly understood by one of ordinary skill in the art. In case of conflict, the present document, including definitions, will control. Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

“Oxo” refers to an oxygen atom double-bonded to a carbon atom.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A}) (R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions for removing deposits, such as iron sulfide deposits, in oil and gas processes as well as inhibiting corrosion of metallic surfaces present in such processes. In some embodiments, a composition comprises a deposit dissolver, such as an iron sulfide dissolver (e.g., a polycarboxylate polymer and/or a salt thereof) along with a corrosion inhibitor. Compositions disclosed herein may optionally comprise (or exclude) other components, such as an additive, a solvent (e.g., an organic solvent), and/or phosphorous.

The compositions disclosed herein are useful in many applications, such as crude oil-based and natural gas-based products, processes, and refinery streams. The compositions are useful for inhibiting corrosion and removing hydrocarbonaceous deposits from metallic and/or mineral surfaces in contact with a fluid in oil and gas applications, including removal of iron sulfide to reduce the risk of corrosion failures due to under deposit corrosion. The compositions can be used in sweet systems (i.e., systems having a relatively high carbon dioxide concentration) or in systems having sour conditions (i.e., relatively high hydrogen sulfide concentration). The compositions are useful in a wide range of climates and under a wide range of process conditions, such as from about 0° C. to about 200° C., where other available corrosion inhibitor and/or cleaner compositions fail.

The deposit dissolver of the composition may be used to dissolve deposits comprising various components, such as iron sulfide, a paraffin, a hydrocarbon, an asphaltene, a biomass, and any combination thereof. The dissolver may comprise, for example, a polycarboxylate polymer.

In some embodiments, the polycarboxylate polymer is an acrylic acid homopolymer, an acrylic acid copolymer, a maleic acid homopolymer, a maleic acid copolymer, or any combination thereof.

The acrylic acid copolymer may comprise an additional monomer selected from the group consisting of maleic acid, fumaric acid, itaconic acid, and any combination thereof.

The acrylic acid copolymer may comprise from about 1 mol % to about 99 mol % of the acrylic acid monomer and from about 99 mol % to about 1 mol % of the co-monomer(s). For example, the acrylic acid copolymer may comprise from about 5 mol % to about 99 mol %, about 10 mol % to about 99 mol %, about 15 mol % to about 99 mol %, about 20 mol % to about 99 mol %, about 25 mol % to about 99 mol %, about 30 mol % to about 99 mol %, about 35 mol % to about 99 mol %, about 40 mol % to about 99 mol %, about 45 mol % to about 99 mol %, about 50 mol % to about 99 mol %, about 55 mol % to about 99 mol %, about 60 mol % to about 99 mol %, about 65 mol % to about 99 mol %, about 70 mol % to about 99 mol %, about 75 mol % to about 99 mol %, about 80 mol % to about 99 mol %, about 85 mol % to about 99 mol %, about 90 mol % to about 99 mol %, about 95 mol % to about 99 mol %, about 5 mol % to about 90 mol %, about 10 mol % to about 80 mol %, about 20 mol % to about 70 mol %, about 30 mol % to about 60 mol %, about 40 mol % to about 60 mol %, or about 50 mol % of the acrylic acid monomer and/or the co-monomer(s).

The maleic acid copolymer may comprise an additional monomer selected from the group consisting of acrylic acid, methacrylic acid, crotonic acid, isocrotonic acid, and any combination thereof.

The maleic acid copolymer may comprise from about 1 mol % to about 99 mol % of the maleic acid monomer and from about 99 mol % to about 1 mol % of the co-monomer(s). For example, the acrylic acid copolymer may comprise from about 5 mol % to about 99 mol %, about 10 mol % to about 99 mol %, about 15 mol % to about 99 mol %, about 20 mol % to about 99 mol %, about 25 mol % to about 99 mol %, about 30 mol % to about 99 mol %, about 35 mol % to about 99 mol %, about 40 mol % to about 99 mol %, about 45 mol % to about 99 mol %, about 50 mol % to about 99 mol %, about 55 mol % to about 99 mol %, about 60 mol % to about 99 mol %, about 65 mol % to about 99 mol %, about 70 mol % to about 99 mol %, about 75 mol % to about 99 mol %, about 80 mol % to about 99 mol %, about 85 mol % to about 99 mol %, about 90 mol % to about 99 mol %, about 95 mol % to about 99 mol %, about 5 mol % to about 90 mol %, about 10 mol % to about 80 mol %, about 20 mol % to about 70 mol %, about 30 mol % to about 60 mol %, about 40 mol % to about 60 mol %, or about 50 mol % of the maleic acid monomer and/or the co-monomer(s).

In certain aspects of the present disclosure, the polycarboxylate polymer is a copolymer comprising acrylic acid and maleic acid.

The polycarboxylate polymer disclosed herein may be fully neutralized, partially neutralized, or not neutralized at all. In certain aspects, the polycarboxylate polymer is phosphonate terminated.

The weight average molecular weight of the polycarboxylate polymer disclosed herein is not particularly limited. In some embodiments, the polycarboxylate polymer comprises a molecular weight of about 500 Da to about 100,000 Da. For example, the molecular weight may be from about 500 Da to about 80,000 Da, from about 500 Da to about 60,000 Da, from about 500 Da to about 40,000 Da, from about 500 Da to about 20,000 Da, from about 500 Da to about 10,000 Da, from about 1,000 Da to about 80,000 Da, from about 5,000 Da to about 80,000 Da, from about 15,000 Da to about 80,000 Da, from about 25,000 Da to about 80,000 Da, from about 35,000 Da to about 80,000 Da, from about 45,000 Da to about 80,000 Da, from about 55,000 Da to about 80,000 Da, from about 1,000 Da to about 50,000 Da, from about 1,000 Da to about 40,000 Da, or from about 2,000 Da to about 45,000 Da.

The dissolver may optionally comprise a multi-functional hydroxy-carboxylic acid and/or additional components, such as allaric acid, altaric acid, altraric acid, altronic acid, arabinaric acid, arabinonic acid, citric acid, dihomocitric acid, fructuronic acid, fuconic acid, fumaric acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, xyluronic acid, tartaric acid, tatronic acid, glyceric acid, malonic acid and pantoic acid, a salt of any of these acids, or any combination thereof.

Suitable salts of the dissolver include alkali metal and alkaline earth metal salts, such as sodium, potassium, lithium, magnesium, calcium and cesium salts. In certain embodiments, the dissolver inhibits the formation of iron sulfide and/or dissolves iron sulfide.

The dissolver may be present in a composition in an amount ranging from about 10 wt. % to about 70 wt. %, such as from about 10 wt. % to about 65 wt. %, about 10 wt. % to about 60 wt. %, about 10 wt. % to about 55 wt. %, about 10 wt. % to about 50 wt. %, about 10 wt. % to about 45 wt. %, about 10 wt. % to about 40 wt. %, about 10 wt. % to about 35 wt. %, about 10 wt. % to about 30 wt. %, about 10 wt. % to about 25 wt. %, about 15 wt. % to about 70 wt. %, about 15 wt. % to about 70 wt. %, about 20 wt. % to about 70 wt. %, about 20 wt. % to about 65 wt. %, about 20 wt. % to about 60 wt. %, about 20 wt. % to about 55 wt. %, about 20 wt. % to about 50 wt. %, about 20 wt. % to about 45 wt. %, or about 20 wt. % to about 40 wt. %, based on total weight of the composition.

In addition to the deposit dissolver, the compositions disclosed herein comprise a corrosion inhibitor. The corrosion inhibitor may comprise a nitrogen-containing compound, for example. The nitrogen-containing compound may comprise, for example, an amine, an imine, or a combination thereof. The amine may be, for example, a tertiary amine or a quaternary amine. In certain aspects, the nitrogen-containing compound may be a cyclic compound. In certain aspects, the nitrogen-containing compound is an imidazoline compound, a quaternary ammonium compound, a quaternary iminium compound, a zwitterionic betaine compound, an amidoamine compound, a pyridinium compound, or any combination thereof.

Illustrative, non-limiting examples of nitrogen-containing compounds that may be used in accordance with the present disclosure include:
(A) an imidazoline of Formula (I):

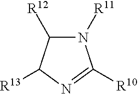

wherein R¹⁰ is a C₁-C₂₀ alkyl group or a C₁-C₂₀ alkoxyalkyl group; R¹² and R¹³ are independently selected from hydrogen or a C₁-C₆ alkyl group; and R¹¹ is hydrogen, a C₁-C₆ alkyl group, a C₁-C₆ hydroxyalkyl group, an aminoalkyl group, an aminoaryl group, an aminoarylalkyl group, an aminoalkylaryl group, or a C₁-C₆ arylalkyl group;
(B) an imidazolinium salt of Formula (II):

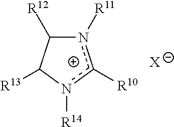

wherein R¹⁰ is a C₁-C₂₀ alkyl group or a C₁-C₂₀ alkoxyalkyl group; R¹² and R¹³ are independently selected from hydrogen or a C₁-C₆ alkyl group; R¹¹ and R¹⁴ are independently selected from hydrogen, a C₁-C₆ alkyl group, a C₁-C₆ hydroxyalkyl group, or a C₁-C₆ arylalkyl group; and
X⁻ is a halide, a carbonate, a sulfonate, a phosphate, or an anion of an organic carboxylic acid;
(C) a bis-quaternized imidazoline compound of Formula (III):

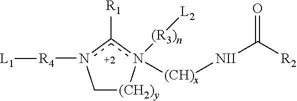

wherein R₁, R₂, R₃ and R₄, are each independently selected from a C₁-C₃₀ alkyl group, a C₁-C₃₀ alkenyl group, a C₁-C₃₀ cycloalkyl group, or a C₁-C₃₀ cycloalkenyl group; optionally wherein R₁, R₂, R₃ and/or R₄, is partially or fully oxygenized, sulfurized, and/or phosphorylized;
L₁ and L₂ are each independently selected from absent, H, —COOH, —SO₃H, —PO₃H₂, —COOR₅, —CONH₂, —CONHR₅, or —CON(R₅)₂;
R⁵ is selected from a C₁-C₁₀ alkyl group, a C₄-C₁₀ aryl group, a C₅-C₁₀ alkylaryl group, a C₅-C₁₀ alkylheteroaryl group, a C₃-C₁₀ cycloalkyl group, or a C₄-C₁₀ heteroaryl group;
n is 0 or 1, and when n is 0, L₂ is absent or H;
x is from 1 to about 10; and
y is from 1 to about 5.

For example, the nitrogen-containing compound may be the imidazoline of Formula (I) or the imidazolinium salt of Formula (II), wherein R¹⁰ is an alkyl mixture of tall oil fatty acid (TOFA), R¹¹ is benzyl, R¹² and R¹³ are each hydrogen, R¹⁴ is hydroxyethyl, and X⁻ is chloride. The nitrogen-containing compound may be, for example, the bis-quaternized imidazoline compound of Formula (III), R¹ and R² are derived from a mixture of tall oil fatty acids and comprise a mixture of C₁₇H₃₃ and C₁₇H₃₁, x is 2, y is 1, R₃ and R₄ are —C₂H₂—, and L₁ and L₂ are —CO₂H, —SO₃H, or —PO₃H₂. Also, the nitrogen-containing compound may be the bis-quaternized imidazoline compound of Formula (III), R¹ and R² are independently a C₁₆-C₁₈ alkyl group; R⁴ is —C₂H₂—; x is 2; y is 1; n is 0; L₁ is —COOH, —SO₃H, or —PO₃H₂ and L₂ is absent or H. Further, the nitrogen-containing compound may be the quaternary ammonium compound and the bis-quaternized imidazoline compound of Formula (III) or the nitrogen-containing compound may be a quaternary ammonium compound of Formula (IV):

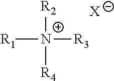

wherein R₁, R₂, and R₃ are independently selected from a C₁ to C₂₀ alkyl group, R₄ is methyl or benzyl, and X⁻ is a halide or methosulfate. Additionally, the nitrogen-containing compound may comprise a pyridinium compound of Formula (V):

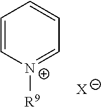

wherein R⁹ is a C₁ to C₁₈ alkyl group, a C₄ to C₁₈ aryl group, or a C₅ to C₂₀ arylalkyl group; and X⁻ is a halide. For example, R⁹ may be benzyl and X⁻ may be a chloride.

A nitrogen-containing compound disclosed herein may be present in a composition in an amount ranging from about 10 wt. % to about 70 wt. %, such as from about 10 wt. % to about 65 wt. %, about 10 wt. % to about 60 wt. %, about 10 wt. % to about 55 wt. %, about 10 wt. % to about 50 wt. %, about 10 wt. % to about 45 wt. %, about 10 wt. % to about 40 wt. %, about 10 wt. % to about 35 wt. %, about 10 wt. % to about 30 wt. %, about 10 wt. % to about 25 wt. %, about 15 wt. % to about 70 wt. %, about 15 wt. % to about 70 wt. %, about 20 wt. % to about 70 wt. %, about 20 wt. % to about 65 wt. %, about 20 wt. % to about 60 wt. %, about 20 wt. % to about 55 wt. %, about 20 wt. % to about 50 wt. %, about 20 wt. % to about 45 wt. %, or about 20 wt. % to about 40 wt. %, based on total weight of the composition.

The compositions disclosed herein may further comprise (or exclude) an organic acid, a solvent, a diol, or a combination thereof. The amount of these components in the composition can be selected depending upon the desired application of the composition. For example, a composition may comprise from about 0.1 wt. % to about 95 wt. %, about 1 wt. % to about 95 wt. %, about 10 wt. % to about 95 wt. %, about 25 wt. % to about 95 wt. %, about 50 wt. % to about 95 wt. %, about 75 wt. % to about 95 wt. %, about 1 wt. % to about 75 wt. %, about 1 wt. % to about 50 wt. %, about 1 wt. % to about 30 wt. %, about 1 wt. % to about 15 wt. %, about 10 wt. % to about 70 wt. %, or about 25 wt. % to about 55 wt. % of one or more of the organic acid, the solvent, the diol, or any combination thereof.

Illustrative, non-limiting examples of the organic acid include acetic acid, lactic acid, formic acid, malic acid, oxalic acid, tartaric acid, uric acid, or any combination thereof.

Illustrative, non-limiting examples of the solvent are methanol, ethanol, trifluoroethanol, propanol, isopropanol, hexafluoroisopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, glycerin, or any combination thereof.

Illustrative, non-limiting examples of the diol include propylene glycol, methylene glycol, ethylene glycol, 1,2-propylene glycol, 1,3-propylene glycol, diethyleneglycol, and any combination thereof.

The compositions disclosed herein may optionally include an additive. Suitable additives include, but are not limited to, an asphaltene inhibitor, a paraffin inhibitor, a scale inhibitor, an emulsifier, a water clarifier, a dispersant, an emulsion breaker, a hydrogen sulfide scavenger, a sulfur-containing compound, a gas hydrate inhibitor, a biocide, a solvent, an additional corrosion inhibitor, an antifoam, a pH modifier, and/or a surfactant.

A composition disclosed herein may comprise from about 0.1 wt. % to about 99 wt. %, from about 0.1 wt. % to about 90 wt. %, from about 0.1 wt. % to about 80 wt. %, from about 0.1 wt. % to about 70 wt. %, from about 0.1 wt. % to about 60 wt. %, from about 0.1 wt. % to about 50 wt. %, from about 0.1 wt. % to about 40 wt. %, from about 0.1 wt. % to about 30 wt. %, from about 0.1 wt. % to about 20 wt. %, from about 0.1 wt. % to about 10 wt. %, from about 0.1 wt. % to about 5 wt. %, or from about 0.5 wt. % to about 3 wt. % of the additive or any combination of additives.

Suitable additional corrosion inhibitors include, but are not limited to, mono-, di- or trialkyl or alkylaryl phosphate esters, phosphate esters of polyols, monomeric fatty acids, and/or oligomeric fatty acids.

In some embodiments, the compositions disclosed herein may include a sulfur-containing compound. If present, the sulfur-containing compound can be included in an amount of about 0.1 wt. % to about 25 wt. %, about 0.5 wt. % to about 20 wt. %, about 1 wt. % to about 10 wt. %, or about 1 wt. % to about 5 wt. %, based on total weight of the composition. The sulfur-containing compound may constitute about 0.1, about 0.5, about 1, about 2, about 3, about 4, about 5, about 6, about 7, about 8, about 9, about 10, about 11, about 12, about 13, about 14, about 15, about 16, about 17, about 18, about 19 or about 20 wt. % of the composition, based on total weight of the composition.

Suitable sulfur-containing compounds include, but are not limited to, compounds that enhance the corrosion inhibiting and/or cleaning performance of the composition. The sulfur-containing compound may include, for example, thioglycolic acid, 3,3′-dithiodipropionic acid, thiourea, 2-mercaptoethanol, L-cysteine, tert-butyl mercaptan, sodium thiosulfate, ammonium thiosulfate, sodium thiocyanate, ammonium thiocyanate, sodium metabisulfite, or any combination thereof. In some embodiments, the sulfur-containing compound is 2-mercaptoethanol.

Suitable asphaltene inhibitors include, but are not limited to, aliphatic sulfonic acids, alkyl aryl sulfonic acids, aryl sulfonates, lignosulfonates, alkylphenol/aldehyde resins and/or similar sulfonated resins, polyolefin esters, polyolefin imides, polyolefin esters with alkyl, alkylenephenyl or alkylenepyridyl functional groups, polyolefin amides, polyolefin amides with alkyl, alkylenephenyl or alkylenepyridyl functional groups, polyolefin imides with alkyl, alkylenephenyl or alkylenepyridyl functional groups, alkenyl/vinyl pyrrolidone copolymers, graft polymers of polyolefins with maleic anhydride or vinyl imidazole, hyperbranched polyester amides, polyalkoxylated asphaltenes, amphoteric fatty acids, salts of alkyl succinates, sorbitan monooleate, and polyisobutylene succinic anhydride.

Suitable paraffin inhibitors include, but are not limited to, paraffin crystal modifiers and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes.

Suitable scale inhibitors include, but are not limited to, phosphates, phosphate esters, phosphoric acids, phosphonates, phosphonic acids, polyacrylam ides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS).

Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers, such as diallyldimethylammonium chloride (DADMAC).

Suitable dispersants include, but are not limited to, aliphatic phosphonic acids with 2-50 carbons, such as hydroxyethyl diphosphonic acid, and aminoalkyl phosphonic acids, e.g., polyaminomethylene phosphonates with 2-10 N atoms, each bearing at least one methylene phosphonic acid group, examples of the latter including ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersants include lignin, or derivatives of lignin, such as lignosulfonate and naphthalene sulfonic acid and derivatives. In some embodiments, a dispersant is selected from dodecyl benzene sulfonate, an oxyalkylated alkylphenol, and/or an oxyalkylated alkylphenolic resin.

Suitable emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, and resins, such as phenolic and epoxide resins.

Suitable hydrogen sulfide scavengers include, but are not limited to, oxidants (e.g., inorganic peroxides, such as sodium peroxide or chlorine dioxide); aldehydes (e.g., of 1-10 carbons, such as formaldehyde, glyoxal, glutaraldehyde, acrolein, or methacrolein; and triazines (e.g., monoethanolamine triazine, monomethylamine triazine, and triazines from multiple amines or mixtures thereof).

Suitable gas hydrate inhibitors include, but are not limited to, thermodynamic hydrate inhibitors, kinetic hydrate inhibitors, and anti-agglomerates. Suitable thermodynamic hydrate inhibitors include, but are not limited to, sodium chloride, potassium chloride, calcium chloride, magnesium chloride, sodium bromide, formate brines (e.g., potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, and triglycerol), sugar alcohols (e.g., sorbitol and mannitol), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

Suitable kinetic hydrate inhibitors and anti-agglomerates include, but are not limited to, polymers and copolymers, polysaccharides (such as hydroxyethylcellulose, carboxymethylcellulose, starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, and alkyl amido betaines), hydrocarbon-based dispersants (such as lignosulfonates, iminodisuccinates, and polyaspartates), amino acids, and proteins.

Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis (hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. For example, a pH modifier may include sodium hydroxide, potassium hydroxide, calcium hydroxide, calcium oxide, sodium carbonate, potassium carbonate, sodium bicarbonate, potassium bicarbonate, magnesium oxide, and magnesium hydroxide. In some embodiments, a pH modifier may comprise a hydrophilic or amphiphilic amine, such as methyldiethanolamine (MDEA).

Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, alkyl and ethoxylated alkyl phosphate esters, and mono- and dialkyl sulfosuccinates and sulfosuccinamates. Nonionic surfactants include, but are not limited to, alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis (2-hydroxyethyl) amine oxides, alkyl polyglucosides, polyalkoxylated glycerides, sorbitan esters and polyalkoxylated sorbitan esters, and alkoxyl polyethylene glycol esters and diesters. Also included are betaines and sultanes, amphoteric surfactants, such as alkyl amphoacetates and amphodiacetates, alkyl amphopropionates and amphodipropionates, and alkyliminodipropionate.

The surfactant may be a quaternary ammonium compound, an amine oxide, an ionic or nonionic surfactant, or any combination thereof. Suitable quaternary ammonium compounds include, but are not limited to, alkyl benzyl ammonium chloride, benzyl cocoalkyl(C₁₂-C₁₈) dimethylammonium chloride, dicocoalkyl(C₁₂-C₁₈) dimethylammonium chloride, ditallow dimethylammonium chloride, di(hydrogenated tallow alkyl) dimethyl quaternary ammonium methyl chloride, methyl bis(2-hydroxyethyl cocoalkyl(C₁₂-C₁₈) quaternary ammonium chloride, dimethyl (2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhexyl) dimethyl quaternary ammonium methyl sulfate.

Suitable solvents include, but are not limited to, an alcohol, a hydrocarbon, a ketone, an ether, an alkylene glycol, a glycol ether, an amide, a nitrile, a sulfoxide, an ester, and water. The solvent may comprise water, isopropanol, methanol, ethanol, 2-ethylhexanol, heavy aromatic naphtha, toluene, ethylene glycol, ethylene glycol monobutyl ether, diethylene glycol monoethyl ether, and/or xylene.

The solvent may be a polar solvent, such as water, brine, seawater, an alcohol (including straight chain or branched aliphatic, such as methanol, ethanol, propanol, isopropanol, butanol, 2-ethylhexanol, hexanol, octanol, decanol, 2-butoxyethanol, etc.), an alkylene glycol (such as methylene glycol, ethylene glycol, 1,2-propylene glycol, 1,3-propylene glycol, etc.), a glycol ether (such as diethyleneglycol monomethyl ether, ethylene glycol monobutyl ether, ethylene glycol dibutyl ether, etc.), a ketone (such as cyclohexanone or diisobutylketone), an ether (such as diethyl ether), an alkylene carbonate (such as propylene carbonate), N-methylpyrrolidinone (NMP), N,N-dimethylformamide, a polyol (such as glycerin), and the like.

Illustrative, non-limiting examples of non-polar solvents suitable for formulation with the composition include, but are not limited to, aliphatic hydrocarbons, such as pentane, hexane, cyclohexane, methylcyclohexane, heptane, decane, dodecane, diesel, and the like; aromatic hydrocarbons, such as toluene, xylene, and heavy aromatic naphtha; and fatty acid derivatives, such as acids, esters, and amides.

The solvent may be compatible with an arctic environment. For example, methanol, ethanol, ethylene glycol or glycerin improve the anti-freeze properties of the composition. Such solvent is typically present in an amount of about 5 wt. % to about 15 wt. %, such as about 10 wt. %, based on total weight of the composition to have an anti-freeze effect.

In some embodiments, a composition disclosed herein consists of or consists essentially of the polycarboxylate polymer and the nitrogen-containing compound. In some embodiments, the composition consists of or consists essentially of the polycarboxylate polymer, the nitrogen-containing compound, and optionally the additive, the organic acid, the solvent, the diol, or any combination thereof. In certain embodiments, the organic acid is malic acid, the solvent is methanol, and the diol is propylene glycol.

Various examples of compositions of the present disclosure can be found in Table 1 with the weight percentage of each component listed.

TABLE 1

| Component | Comp 1 | Comp 2 | Comp 3 | Comp 4 | Comp 5 | Comp 6 | Comp 7 |
|---|---|---|---|---|---|---|---|
| Benzyl-(C12-C18 Linear | 25 | 25 | 25 | 25 | 25 | 25 | 25 |
| Alkyl)-Dimethyl-Ammonium | | | | | | | |
| Chloride, Tall Oil Fatty | | | | | | | |
| Acids, Rxn Product with | | | | | | | |
| diethylenetriamine and | | | | | | | |
| Acrylic Acid | | | | | | | |
| Hydrolyzed polymaleic acid | 37.5 | 24.75 | | | | 18.75 | |
| Polymaleic acid (50%) | | | 37.5 | | | | 18.75 |
| Acrylic maleic copolymer | | | | 37.5 | | | |
| Acrylic acid homopolymer | | | | | 37.5 | | |
| Malic acid (50%) | | | | | | 18.75 | 18.75 |
| Water | 18.8 | 40.25 | 18.8 | 18.8 | 18.8 | 18.8 | 18.8 |
| Methanol | 18.7 | 5 | 18.7 | 18.7 | 18.7 | 18.7 | 18.7 |
| propylene glycol | | 5 | | | | | |

In some embodiments, compositions of the present disclosure may be prepared by combining the deposit dissolver and the corrosion inhibitor with a solvent to form a solution. If desired, additional components and/or additives may be added to the solution.

The compositions of the present disclosure may be used for inhibiting corrosion of metallic surfaces and dissolving deposits, such as iron sulfide and/or hydrocarbonaceous deposits, in oil and gas applications. The compositions may be used in any industry where it is desirable to inhibit corrosion and dissolve a deposit.

In some embodiments, the present disclosure provides a method of dissolving a deposit and inhibiting corrosion of a metallic surface. The method includes adding a composition to an aqueous medium, wherein the aqueous medium comprises the deposit and the metallic surface. The composition comprises a polycarboxylate polymer and a nitrogen-containing compound, wherein the nitrogen-containing compound comprises an amine, an imine, or a combination thereof. The method also includes dissolving at least a portion of the deposit and inhibiting corrosion of the metallic surface.

In certain methods disclosed herein, a surface in contact with the aqueous medium comprises the deposit. Optionally, the metallic surface comprises the deposit.

The metal of the metallic surface is not particularly limited. The technology of the present disclosure may be used in connection with surfaces comprising a variety of different metals, such as iron and/or ferrous metals.

When the deposit comprises iron sulfide, methods disclosed herein further comprise increasing a soluble iron percentage in the aqueous medium. For example, the soluble iron percentage may increase by about 5% to about 100%, such as from about 10% to about 100%, about 35% to about 100%, about 50% to about 100%, about 65% to about 100%, or about 80% to about 100%.

The composition may be added to the aqueous medium at a concentration of at least about 0.005 wt. %. For example, the composition may be added at a concentration of about 0.005 wt. % to about 25 wt. %, about 0.005 wt. % to about 20 wt. %, about 0.005 wt. % to about 15 wt. %, about 0.005 wt. % to about 10 wt. %, about 0.005 wt. % to about 5 wt. %, about 0.005 wt. % to about 1 wt. %, about 0.005 wt. % to about 0.5 wt. %, about 0.005 wt. % to about 0.05 wt. %, about 0.05 wt. % to about 25 wt. %, about 0.5 wt. % to about 25 wt. %, about 1 wt. % to about 25 wt. %, about 5 wt. % to about 25 wt. %, about 10 wt. % to about 25 wt. %, about 15 wt. % to about 25 wt. %, or about 20 wt. % to about 25 wt. %.

In some embodiments, a method of the present disclosure may be carried out by treating a gas and/or liquid stream with an effective amount of a composition as described herein. The methods may be carried out in aqueous systems, oil systems and/or gas systems. For example, the compositions and methods may be used for dissolving iron sulfide deposits on heat exchanger surfaces. Certain methods may include applying a composition disclosed herein to a gas or liquid produced or used in the production, transportation, storage, and/or separation of crude oil or natural gas. In some embodiments, the compositions may be applied to a gas stream used or produced in a coal-fired process, such as a coal-fired power plant. In certain embodiments, the compositions may be applied to a gas or liquid produced or used in a waste-water process, a farm, a slaughter house, a land-fill, a municipality waste-water plant, a coking coal process, and/or a biofuel process.

The compounds and compositions disclosed herein may be added to an aqueous medium. The aqueous medium may comprise water, gas, and/or liquid hydrocarbon. In some embodiments, a compound or composition may be added to a liquid hydrocarbon. The liquid hydrocarbon can be any type of liquid hydrocarbon including, but not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, and any combination thereof. In some embodiments, the fluid or gas may comprise a refined hydrocarbon product.

In some embodiments, the aqueous medium may comprise a chloride-containing salt, such as, but not limited to, sodium chloride, calcium chloride, magnesium chloride, potassium chloride, or a combination thereof. In certain embodiments, the aqueous medium comprises sodium bicarbonate, sodium bromide, or a combination thereof.

A fluid or gas treated with a composition of the present disclosure may be at any selected temperature, such as ambient temperature or an elevated temperature. The fluid (e.g., liquid hydrocarbon) or gas may be at a temperature of from about 40° C. to about 250° C. In some embodiments, the fluid or gas may be at a temperature of from about −50° C. to about 300° C., about 0° C. to about 200° C., about 10° C. to about 100° C., or about 20° C. to about 90° C. For example, the fluid or gas may be at a temperature of about −20° C., about −15° C., about −10° C., about −5° C., or about 0° C. In certain embodiments, the fluid or gas can be found in an arctic environment and can have a temperature and salinity typical of such an environment.

The compositions of the disclosure may be added to a fluid at various levels of water cut. For example, the water cut may be from about 0% to about 100% volume/volume (v/v), from about 1% to about 80% v/v, or from about 1% to about 60% v/v. The fluid may be an aqueous medium that contains various levels of salinity. For example, the fluid may have a salinity of about 0% to about 25%, about 1% to about 24%, or about 10% to about 25% weight/weight (w/w) total dissolved solids (TDS).

The fluid and/or gas to which the compositions of the disclosure are introduced can be contained in and/or exposed to many different types of devices. For example, the fluid and/or gas may be contained in a device or apparatus that transports fluid or gas from one point to another, such as an oil and/or gas pipeline. The device or apparatus can be part of an oil and/or gas refinery, such as a pipeline, a separation vessel, a dehydration unit, or a gas line. The compositions can be introduced to large diameter flow lines of from about 1 inch to about 4 feet in diameter, small gathering lines, small flow lines and headers. The fluid can be contained in and/or exposed to an apparatus or device used in oil extraction and/or production, such as a wellhead. The device or apparatus may be part of a coal-fired power plant. The device or apparatus may be a scrubber (e.g., a wet flue gas desulfurizer, a spray dry absorber, a dry sorbent injector, a spray tower, a contact or bubble tower, or the like). The device or apparatus may be a cargo vessel, a storage vessel, a holding tank, or a pipeline connecting the tanks, vessels, or processing units.

The compositions may be introduced into a fluid or gas by any appropriate method for ensuring dispersal through the fluid or gas. In some embodiments, a composition may be added to the hydrocarbon fluid before the hydrocarbon fluid contacts a surface in the system. The composition may be added at a point in a flow line upstream from the point at which the deposit is to be dissolved. The compositions may be injected/added using mechanical equipment, such as chemical injection pumps, piping tees, injection fittings, atomizers, quills, and the like. In certain embodiments, the compositions of the disclosure may be pumped into an oil and/or gas pipeline using an umbilical line. In other embodiments, a capillary injection system may be used to deliver the composition to a selected fluid.

The compositions may be injected into a stream as an aqueous or non-aqueous solution, a mixture, or a slurry. The compositions may be applied to a fluid or gas to provide any selected concentration of components. For example, the composition may be added to a flow line to provide an effective treating dose of the desired component, such as deposit dissolver and/or corrosion inhibitor, from about 0.01 ppm to about 50,000 ppm. The compositions may be applied to a fluid or gas to provide a concentration of deposit dissolver and/or corrosion inhibitor of, for example, about 1 ppm to about 50,000 ppm, about 1 ppm to about 40,000 ppm, about 1 ppm to about 30,000 ppm, about 1 ppm to about 20,000 ppm, about 1 ppm to about 10,000, about 1 ppm to about 5,000 ppm, about 1 ppm to about 1,000 ppm, about 10 ppm to about 5,000 ppm, about 25 ppm to about 5,000 ppm, or about 50 ppm to about 5,000 ppm.

In accordance with the methods disclosed herein, the composition may be applied continuously, in batch, or a combination thereof. For example, a dosage rate for continuous treatment may range from about 10 ppm to about 500 ppm or about 10 ppm to about 200 ppm. A dosage rate for batch treatments may range from, for example, about 10 ppm to about 400,000 ppm or about 10 ppm to about 20,000 ppm. The composition can also be applied as a pill to a pipeline, for example, to provide a high dose (e.g., about 20,000 ppm) of a component, such as iron sulfide dissolver and/or corrosion inhibitor, of the composition.

The foregoing may be better understood by reference to the following examples, which are intended for illustrative purposes and are not intended to limit the scope of the disclosure or its application in any way.

### EXAMPLES

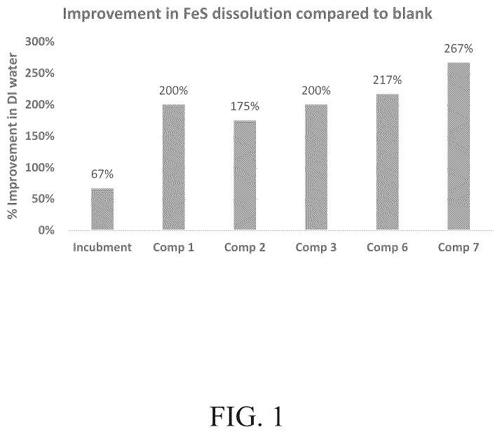

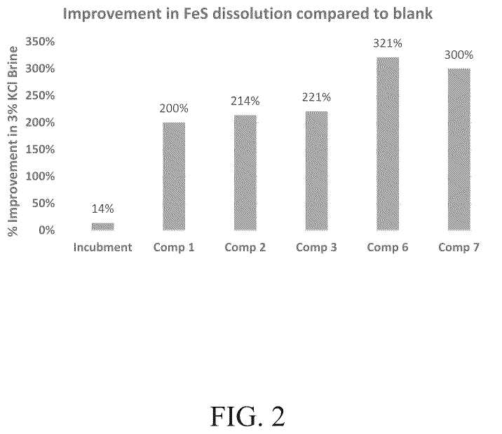

The ability of various compositions (Comp 1-7 above) to dissolve iron sulfide and inhibit corrosion was tested. The effectiveness of the compositions for their iron sulfide solubilization was determined by measuring solubilized iron after dosing samples containing a suspension of iron sulfide (30 ppm) treated with a set of about 250 ppm of the compositions. The solubilization tests were conducted using different water compositions. Evaluations were conducted at a test temperature of about 65° C. for about 30 minutes. The iron sulfide solubilization performance of the compositions was determined and are reported as improvement (%) in FeS dissolution compared to untreated sample. Performance data, as shown in FIGS. 1-2, in different aqueous media clearly show that the disclosed compositions are significantly more effective in dissolving iron sulfide as compared to the incumbent product.

The synthetic brine included about 5.64 g of calcium chloride (CaCl₂)), about 7.2 g of magnesium chloride (MgCl₂), about 1.32 g of potassium chloride (KCl), about 0.96 g of sodium sulfate (Na₂SO₄), about 16.8 g of sodium bicarbonate (NaHCO₃), about 205.8 g of sodium chloride (NaCl), about 1.08 g of sodium bromide (NaBr), about 10.8 g acetic acid and about 12 L of demineralized water.

The second aqueous solution included about 3.5% (w/w) of sea salts in demineralized water.

The third solution included about 3.0% (w/w) of KCl in demineralized water.

Finally, deionized water was used.

One mole of ferrous chloride (FeCl₂) was reacted with one mole of sodium sulfide (Na₂S) to produce one mole of iron sulfide (FeS) suspended in deionized water. The FeS composition containing approximately 30 ppm Fe was maintained at about 65° C. for about 10 minutes after which the compositions were introduced at about 250 ppm and about 500 ppm. The treated samples were returned to the hot water bath for a 30-minute heating cycle. Then, the treated samples were removed from the hot water bath and allowed to cool to room temperature for 2 to 4 hours. After, the samples were shaken to ensure resuspension of the FeS. The suspensions were filtered through a 0.2 μm filter with solubilized iron captured in the water phase and submitted for analysis of the filtered residue by Inductively Coupled Argon Plasma Analysis. In addition to the composition treated samples, an untreated sample of the FeS suspension was included for analysis, which served as the control sample (Blank).

Wheel box testing was conducted to evaluate three different concentrations of each of composition in hydrotreated light distillate as oil. A further sample of oil without any composition was also evaluated (labeled as “untreated”).

The wheel box testing conditions were as follow:
Brine: Oil (saturated with H₂S) ratio was 1:3
rotation rate of the wheel: 26 revolutions per minute (RPM),
coupons used: ¼″ by 7⅜″ 1018 mild steel with sandblast finish
test temperature: 160° F. (71° C.)
test duration: 24 hours

The % protection of the compositions as a function of dose is shown in Table 2. Table 3 shows the corrosion rate of the blank compared to the dosed coupons in mils per year (mpy).

TABLE 2

| Conc. (ppm) | Comp 1 | Comp 2 | Comp 3 | Comp 6 | Comp 7 |
|---|---|---|---|---|---|
| 1,000 ppm | 98% | 98% | 98% | 98% | 98% |
| 2,500 ppm | 99% | 99% | 98% | 99% | 98% |
| 5,000 ppm | 99% | 99% | 99% | 99% | 99% |
| 10,000 ppm | 99% | 99% | 99% | 99% | 99% |

TABLE 3
Corrosion Rates (mpy) at different concentrations

| | | Un- | Comp | Comp | Comp | Comp | Comp |
|---|---|---|---|---|---|---|---|
| Conc. (ppm) | | treated | 1 | 2 | 3 | 6 | 7 |
| 0 | ppm | 308.4 | | | | | |
| 1,000 | ppm | | 2.989 | 3.233 | 3.42 | 3.294 | 2.87 |
| 2,500 | ppm | | 2.684 | 2.379 | 3.48 | 2.928 | 2.44 |
| 5,000 | ppm | | 2.318 | 2.562 | 2.38 | 2.562 | 2.26 |
| 10,000 | ppm | | 2.257 | 2.684 | 2.26 | 2.806 | 2.38 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of dissolving a deposit and inhibiting corrosion of a metallic surface, the method comprising:
adding a composition to an aqueous medium, the aqueous medium comprising the deposit and the metallic surface, the composition comprising:
a polycarboxylate polymer; and
a nitrogen-containing compound, the nitrogen-containing compound comprising an amine, an imine, or a combination thereof;
dissolving at least a portion of the deposit; and
inhibiting corrosion of the metallic surface,
wherein the composition is added to the aqueous medium at a concentration of at least about 0.005 wt. %.

2. The method of claim 1, wherein the amine is a tertiary amine or a quaternary amine.

3. The method of claim 1, wherein the nitrogen-containing compound is a cyclic compound.

4. The method of claim 1, wherein the nitrogen-containing compound is an imidazoline compound, a quaternary ammonium compound, a quaternary iminium compound, a zwitterionic betaine compound, an amidoamine compound, a pyridinium compound, or any combination thereof.

5. The method of claim 1, wherein the nitrogen-containing compound is:
(A) an imidazoline of Formula (I): 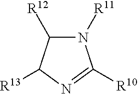
wherein R¹⁰ is a C₁-C₂₀ alkyl group or a C₁-C₂₀ alkoxyalkyl group; R¹² and R¹³ are independently selected from hydrogen or a C₁-C₆ alkyl group; and R¹¹ is hydrogen, a C₁-C₆ alkyl group, a C₁-C₆ hydroxyalkyl group, an aminoalkyl group, an aminoaryl group, an aminoarylalkyl group, an aminoalkylaryl group, or a C₁-C₆ arylalkyl group;
(B) an imidazolinium salt of Formula (II): 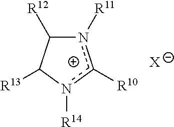
wherein R¹⁰ is a C₁-C₂₀ alkyl group or a C₁-C₂₀ alkoxyalkyl group; R¹² and R¹³ are independently selected from hydrogen or a C₁-C₆ alkyl group; R¹¹ and R¹⁴ are independently selected from hydrogen, a C₁-C₆ alkyl group, a C₁-C₆ hydroxyalkyl group, or a C₁-C₆ arylalkyl group; and
X⁻ is a halide, a carbonate, a sulfonate, a phosphate, or an anion of an organic carboxylic acid;
(C) a bis-quaternized imidazoline compound of Formula (III): 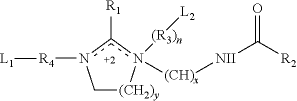
wherein R₁, R₂, R₃ and R₄, are each independently selected from a C₁-C₃₀ alkyl group, a C₁-C₃₀ alkenyl group, a C₁-C₂₀ cycloalkyl group, or a C₁-C₂₀ cycloalkenyl group; optionally wherein R₁, R₂, R₃ and/or R₄, is partially or fully oxygenized, sulfurized, and/or phosphorylized;
L₁ and L₂ are each independently selected from absent, H, —COOH, —SO₃H, —PO₃H₂, —COOR₅, —CONH₂, —CONHR₅, or —CON(R₅)₂;
R⁵ is selected from a C₁-C₁₀ alkyl group, a C₄-C₁₀ aryl group, a C₅-C₁₀ alkylaryl group, a C₅-C₁₀ alkylheteroaryl group, a C₃-C₁₀ cycloalkyl group, or a C₄-C₁₀ heteroaryl group;
n is 0 or 1, and when n is 0, L₂ is absent or H;
x is from 1 to about 10; and
y is from 1 to about 5; or
(D) any combination thereof.

6. The method of claim 1, wherein the nitrogen-containing compound is a quaternary ammonium compound of Formula (IV): 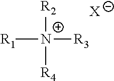
wherein R₁, R₂, and R₅ are independently selected from a C₁ to C₂₀ alkyl group, R₄ is methyl or benzyl, and X⁻ is a halide or methosulfate.

7. The method of claim 1, wherein the nitrogen-containing compound comprises a pyridinium compound of Formula (V): 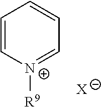
wherein R⁹ is a C₁ to C₁₈ alkyl group, a C₄ to C₁₈ aryl group, or a C₅ to C₂₀ arylalkyl group; and
X⁻ is a halide.

8. The method of claim 1, wherein the composition further comprises an organic acid, a solvent, a diol, or a combination thereof.

9. The method of claim 8, wherein the organic acid is acetic acid, lactic acid, formic acid, malic acid, oxalic acid, tartaric acid, uric acid, or a combination thereof.

10. The method of claim 8, wherein the organic acid is malic acid, the solvent is methanol, and the diol is propylene glycol.

11. The method of claim 1, wherein the polycarboxylate polymer is an acrylic acid homopolymer, an acrylic acid copolymer, a maleic acid homopolymer, or a maleic acid copolymer.

12. The method of claim 1, wherein the composition comprises from about 10 wt. % to about 70 wt. % of the polycarboxylate polymer and from about 10 wt. % to about 70 wt. % of the nitrogen-containing compound.

13. The method of claim 1, wherein the aqueous medium comprises a chloride-containing salt, sodium bicarbonate, sodium bromide, or any combination thereof.

14. The method of claim 1, wherein the aqueous medium comprises water, a gas, a liquid hydrocarbon, or any combination thereof.

15. The method of claim 1, wherein the deposit comprises a member selected from the group consisting of iron sulfide, a paraffin, a hydrocarbon, an asphaltene, a biomass, and any combination thereof.

16. The method of claim 1, wherein the composition consists of or consists essentially of the polycarboxylate polymer and the nitrogen-containing compound.

17. A composition, comprising:
a polycarboxylate polymer; and
a nitrogen-containing compound, the nitrogen-containing compound comprising an amine, an imine, or a combination thereof.

18. The composition of claim 17, wherein the nitrogen-containing compound is an imidazoline compound, a quaternary ammonium compound, a quaternary iminium compound, a zwitterionic betaine compound, an amidoamine compound, a pyridinium compound, or any combination thereof.

19. The composition of claim 17, wherein the composition further comprises an organic acid, a solvent, a diol, or a combination thereof.

20. The composition of claim 17, wherein the polycarboxylate polymer is an acrylic acid homopolymer, an acrylic acid copolymer, a maleic acid homopolymer, or a maleic acid copolymer.
